(19) United States
(12) Patent Application Publication
(10) Pub. No.: US 2018/0292688 A1
(43) Pub. Date: Oct. 11, 2018

(54) LIQUID CRYSTAL DISPLAY

(71) Applicant: Ortus Technology Co., Ltd., Hino (JP)

(72) Inventors: Eiichi ONAKA, Hino (JP); Norishige IWANAMI, Hino (JP)

(73) Assignee: Ortus Technology Co., Ltd., Hino (JP)

(21) Appl. No.: 16/006,249

(22) Filed: Jun. 12, 2018

Related U.S. Application Data
(63) Continuation of application No. PCT/JP2016/050491, filed on Jan. 8, 2016.

(51) Int. Cl. G02F 1/1339; G02F 1/1334; G02F 1/1343

(52) U.S. Cl. CPC G02F 1/1339; G02F 1/1334; G02F 1/13439; G02F 2202/16; G02F 2202/28; G02F 2001/13398; G02F 2001/13345

(57) ABSTRACT

A liquid crystal display includes: a polymer dispersed liquid crystal layer that is enclosed in an area surrounded by first and second substrates and a seal member; a display electrode that is provided on the first substrate in a view area; a first adhesion improving film that is provided on the first substrate; a first organic insulating film that is provided on the display electrode and the first adhesion improving film, and contacts the seal member; a common electrode that is provided on the second substrate in the view area; a second adhesion improving film that is provided on the second substrate; and a second organic insulating film that is provided on the common electrode and the second adhesion improving film, and contacts the seal member.

### CROSS-REFERENCE TO RELATED APPLICATIONS

This application is a Continuation Application of PCT Application No. PCT/JP2016/050491, filed Jan. 8, 2016, the entire contents of which are incorporated herein by reference.

### BACKGROUND OF THE INVENTION

### 1. Field of the Invention

The present invention relates generally to a liquid crystal display, and in particular, to a liquid crystal display that uses a polymer dispersed liquid crystal.

### 2. Description of the Related Art

Polymer dispersed liquid crystals have a structure in which liquid crystals are phase-separated in a polymer formed into a three-dimensional network (polymer network), and create a scattering state of light and a transmissive state of light respectively, while liquid crystal molecules are randomly oriented along a side wall of the polymer network and while liquid crystal molecules are arrayed in a direction of an electric field upon application of the electric field (e.g., Patent Literature 1). The degree of scattering is determined by a voltage applied to the liquid crystals, and the voltage applied to the liquid crystals is determined by a partial voltage of a polymer material and the liquid crystals.

For example, a liquid crystal display is formed by holding a polymer dispersed liquid crystal layer between two glass substrates, and bonding the two glass substrates together using a seal member so as to enclose the polymer dispersed liquid crystal layer. In a manufacturing process of this liquid crystal display, a force is sometimes applied to the seal member due to heat transfer at a time of LSI bonding, ultrasonic cleaning, etc. At this time, a quality problem occurs, such as peeling at an interface of at least any of the seal member, an insulating film that contacts the seal member, and the glass substrate that contacts the seal member, resulting in a decrease in the yield and reliability.

### BRIEF SUMMARY OF THE INVENTION

According to an aspect of the present invention, there is provided a liquid crystal display comprising:

first and second substrates that are arranged opposite to each other;

a seal member that bonds the first and second substrates together;

a polymer dispersed liquid crystal layer that is enclosed in an area surrounded by the first and second substrates and the seal member;

a display electrode that is provided on the first substrate in a view area;

a first adhesion improving film that is provided on the first substrate so as to at least partially overlap with the seal member;

a first organic insulating film that is provided on the display electrode and the first adhesion improving film, and contacts the seal member;

a common electrode that is provided on the second substrate in the view area;

a second adhesion improving film that is provided on the second substrate so as to at least partially overlap with the seal member; and

a second organic insulating film that is provided on the common electrode and the second adhesion improving film, and contacts the seal member.

According to an aspect of the present invention, there is provided a liquid crystal display comprising:

first and second substrates that are arranged opposite to each other;

a seal member that bonds the first and second substrates together;

a polymer dispersed liquid crystal layer that is enclosed in an area surrounded by the first and second substrates and the seal member;

a signal interconnection that is provided on the first substrate;

an insulating film that is provided on the signal interconnection;

a display electrode that is provided on the insulating film in a view area and is electrically coupled to the signal interconnection via a contact plug;

a first adhesion improving film that is provided on the first substrate so as to at least partially overlap with the seal member;

a first organic insulating film that is provided on the display electrode and the first adhesion improving film, and contacts the seal member;

a common electrode that is provided on the second substrate in the view area;

a second adhesion improving film that is provided on the second substrate so as to at least partially overlap with the seal member; and

a second organic insulating film that is provided on the common electrode and the second adhesion improving film, and contacts the seal member,

wherein the first adhesion improving film is formed in a discontinuous manner to include a portion, the portion overlapping with the signal interconnection.

### BRIEF DESCRIPTION OF THE SEVERAL VIEWS OF THE DRAWINGS

FIG. 1 is a plane view of a liquid crystal display according to a first embodiment of the present invention.

FIG. 2 is a cross-sectional view of the liquid crystal display taken along line A-A′ in FIG. 1.

FIG. 3 is a cross-sectional view of the liquid crystal display taken along line B-B′ in FIG. 1.

FIG. 4 is a plane view of a liquid crystal display according to a comparative example.

FIG. 5 is a cross-sectional view of the liquid crystal display taken along line A-A′ in FIG. 4.

FIG. 6 is a cross-sectional view of the liquid crystal display taken along line B-B′ in FIG. 4.

FIG. 7 is a plane view of a liquid crystal display according to a second embodiment of the present invention.

FIG. 8 is a cross-sectional view of the liquid crystal display taken along line A-A′ in FIG. 7.

FIG. 9 is a plane view of a liquid crystal display according to a third embodiment of the present invention.

FIG. 10 is a cross-sectional view of the liquid crystal display taken along line B-B′ in FIG. 9.

### DETAILED DESCRIPTION OF THE INVENTION

A description will now be given of the embodiments with reference to the accompanying drawings. It should be noted that the drawings are schematic or conceptual, and the dimensions and scales of the drawings are not necessarily the same as the actual products. Where the same portion is depicted in different drawings, the dimensions and scale of one drawing may be different from those of another. Several embodiments described below merely show exemplary apparatuses and methods that implement the technical ideas of the present invention. The technical ideas are not limited by the element shapes, structures, arrangements, etc. described below. In the description below, structural elements having substantially the same functions and configurations will be denoted by the same reference symbols, and a repetitive description of such elements will be given only where necessary.

### First Embodiment

### [1] Configuration of Liquid Crystal Display

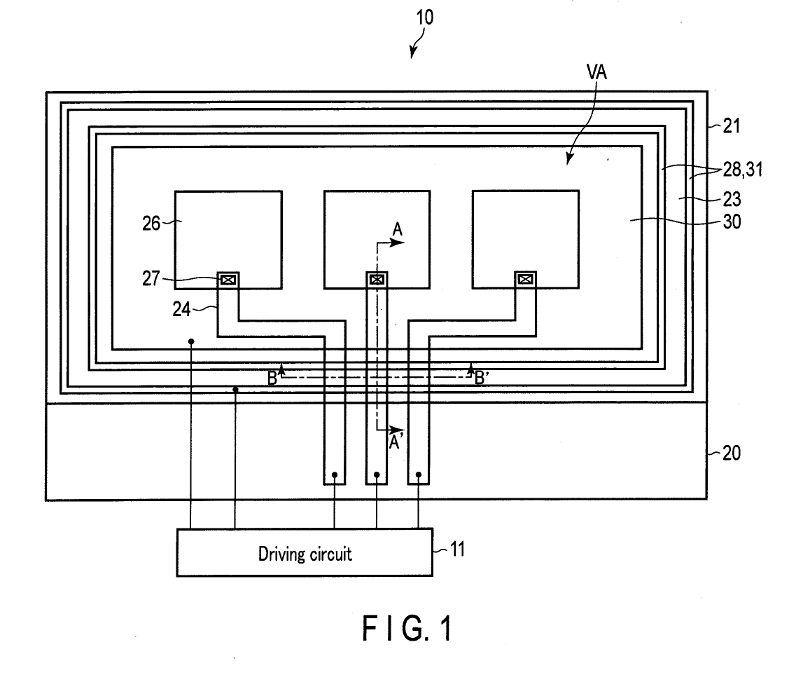

FIG. 1 is a plane view of a liquid crystal display 10 according to a first embodiment of the present invention.

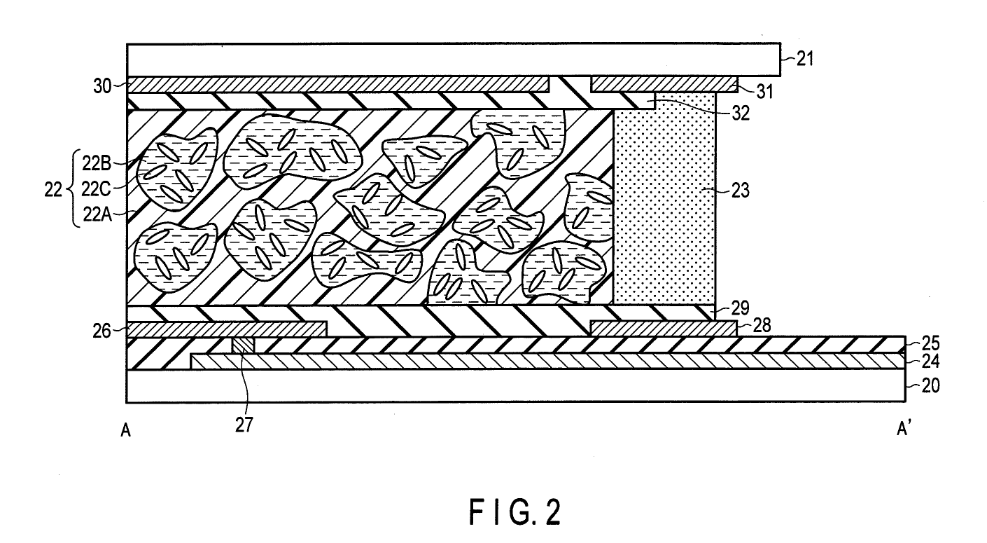

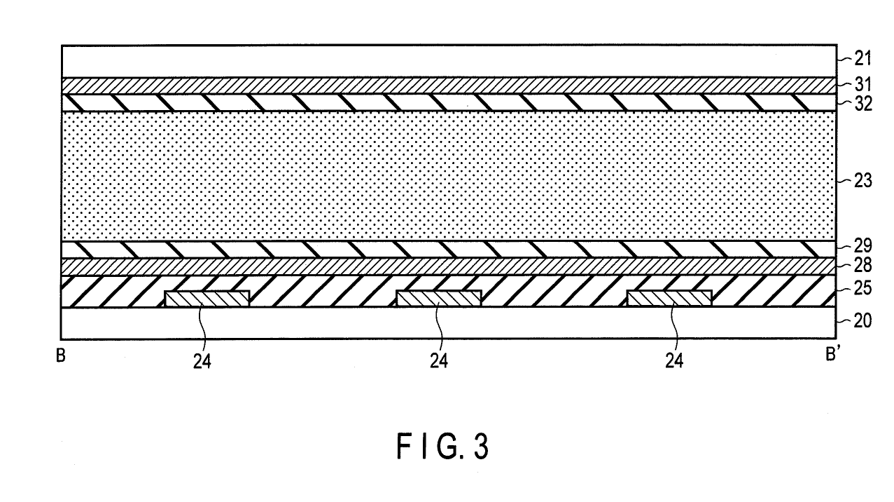

FIG. 2 is a cross-sectional view of the liquid crystal display 10 taken along line A-A′ in FIG. 1. FIG. 3 is a cross-sectional view of the liquid crystal display 10 taken along line B-B′ in FIG. 1. The liquid crystal display 10 according to the present embodiment is a pattern display-type liquid crystal display that is capable of displaying a plurality of patterns, such as characters and figures.

The liquid crystal display 10 includes: a first substrate 20 on which a display electrode is provided; a second substrate 21 on which a common electrode is provided and which is arranged opposite to the first substrate 20; and a liquid crystal layer 22 held between the first substrate 20 and the second substrate 21. For example, the first substrate 20 and the second substrate 21 are formed of a glass substrate.

The first substrate 20 and the second substrate 21 are bonded together by a frame-shaped seal member 23 that surrounds a view area VA. The liquid crystal layer 22 is enclosed in a space between the first substrate 20 and the second substrate 21 by the seal member 23. For example, the seal member 23 is made of an organic adhesive material, and is formed by a printing process. A thickness (cell gap) of the liquid crystal layer 22 is defined by a gap material mixed in the liquid crystal layer 22 and the seal member 23, and is, for example, approximately 1 to 10 μm.

The liquid crystal layer 22 is formed of a polymer dispersed liquid crystal (PDLC) or a polymer network liquid crystal (PNLC). The PDLC has a structure in which liquid crystals 22B are dispersed in a polymer layer (polymer network) 22A, that is, a structure in which the liquid crystals 22B are phase-separated in the polymer layer 22A. Alternatively, the liquid crystals 22B in the polymer layer 22A may have a continuous phase.

A photocurable resin may be used as the polymer layer 22A. For example, the PDLC is configured by radiating ultraviolet light to a solution containing photopolymerized polymer precursors (monomers) mixed with liquid crystals, to polymerize the monomers so that the liquid crystals are dispersed in the network of the resultant polymer. Nematic liquid crystals with positive dielectric anisotropy are used, for example, as the liquid crystals 22B. Namely, if a voltage is not applied to the liquid crystal layer 22, liquid crystal molecules 22C are randomly oriented in the polymer layer 22A, and if a voltage is applied to the liquid crystal layer 22, the liquid crystal molecules 22C stand in a direction of an electric field (a long axis of the liquid crystal molecules 22C faces in the direction of the electric field).

A plurality of signal interconnections 24 are provided on the liquid crystal layer 22 side of the first substrate 20. An insulating film 25 is provided on the signal interconnections 24. A plurality of display electrodes 26 are provided on the insulating film 25 in the view area VA. Each of the plurality of display electrodes 26 is processed so that the planar shape thereof has a desired pattern. In FIG. 1, the planar shape of the display electrodes 26 is presented simply in a square shape. The display electrode is electrically coupled to its corresponding signal interconnection 24 via a contact plug 27. For example, the contact plug 27 is formed by the same process as the display electrode 26. Specifically, the contact plug 27 is integrally formed with the display electrode 26 by forming a contact hole in the insulating film 25 and embedding the same conductive material as that of the display electrode 26 in the contact hole. The signal interconnection 24 is drawn from an end of the display electrode 26 to the outside of the view area VA, and functions to apply a voltage to the display electrode 26.

On the insulating film 25, a first adhesion improving film 28 is provided at a position that overlaps with the seal member 23 in a planar view. Namely, the planar shape of the first adhesion improving film 28 is a shape of a square frame, as shown in FIG. 1. A width of the first adhesion improving film 28 is set to be larger than a width of the seal member 23. The first adhesion improving film 28 is made of a highly-adhesive material.

A first organic insulating film 29 is provided on the display electrodes 26, the first adhesion improving film 28, and the insulating film 25 in a manner to contact the liquid crystal layer 22. The first organic insulating film 29 is formed to cover the entire view area VA. Therefore, in consideration of the processing accuracy, the first organic insulating film 29 is disposed so as to overlap with the seal member 23 around the view area VA. The seal member 23 is provided on the first organic insulating film 29.

The display electrode 26, the first adhesion improving film 28, the contact plug 27, and the signal interconnection 24 are made of a transparent conductive material, such as ITO (Indium Tin Oxide). A film thickness of the display electrode 26, the first adhesion improving film 28, and the signal interconnection 24 is, for example, approximately 100 Å to 1000 Å. The insulating film 25 is, for example, formed of a silicon nitride film having a film thickness of 1000 Å to 10000 Å. The first organic insulating film 29 is, for example, formed of a polyimide film having a film thickness of 100 Å to 1000 Å. Forming the display electrode 26 and the first adhesion improving film 28 by the same process can simplify the manufacturing process.

A common electrode 30 is provided on the liquid crystal layer 22 side of the second substrate 21. The common electrode 30 is provided in a planar shape on the entire surface of the view area VA, and has at least a size that makes the common electrode 30 overlap with all of the display electrodes 26. On the liquid crystal layer 22 side of the second substrate 21, a second adhesion improving film 31 is provided at a position that overlaps with the seal member 23 in a planar view. The planar shape of the second adhesion improving film 31 has the same condition as that of the planar shape of the first adhesion improving film 28. The second adhesion improving film 31 is made of a highly-adhesive material in a manner similar to the first adhesion improving film 28.

A second organic insulating film 32 is provided on the common electrode 30, the second adhesion improving film 31, and the second substrate 21 in a manner to contact the liquid crystal layer 22. The second organic insulating film 32 is formed to cover the entire view area VA. Therefore, in consideration of the processing accuracy, the second organic insulating film 32 is disposed so as to overlap with the seal member 23 around the view area VA. The seal member 23 is provided on the second organic insulating film 32 and the second adhesion improving film 31.

The common electrode 30 and the second adhesion improving film 31 are, for example, formed of ITO having a film thickness of about 100 Å to 1000 Å. The second organic insulating film 32 is, for example, formed of a polyimide film having a film thickness of about 100 Å to 1000 Å. Forming the common electrode 30 and the second adhesion improving film 31 by the same process can simplify the manufacturing process.

### [2] Operation

An operation of the liquid crystal display 10 having the above-described configuration will be described. The liquid crystal display 10 includes a driving circuit 11. The driving circuit 11 is electrically coupled to the plurality of signal interconnections 24, the common electrode 30, the first adhesion improving film 28, and the second adhesion improving film 31. For example, the driving circuit 11 is bonded on the first substrate 20 in a peripheral area thereof excluding the view area VA. The driving circuit 11 operates based on a control signal supplied from outside.

The driving circuit 11 applies an electric field to the liquid crystal layer 22 by applying voltages to the display electrodes 26 and the common electrode 30. If an electric field is not applied to the liquid crystal layer 22, that is, the same voltage is applied to the display electrodes 26 and the common electrode 30, the liquid crystal molecules are randomly oriented. In this case, if white light is entered into the liquid crystal layer 22, the incident light is scattered, and the liquid crystal layer 22 is observed to be in a cloudy state from the outside (white display).

On the other hand, if an electric field is applied to the liquid crystal layer 22, that is, a high voltage (e.g., 5 V) is applied to one of the display electrode 26 or the common electrode 30, and a low voltage (e.g., 0 V) is applied to the other of them, the liquid crystal molecules are oriented in the direction of the electric field (a direction perpendicular to the substrate). In this case, if white light is entered into the liquid crystal layer 22, the incident light is transmitted, and the liquid crystal layer 22 is observed to be in a transparent state from the outside (black display). Since continuing to apply a direct-current voltage to the liquid crystal layer causes the liquid crystals to deteriorate, an inversion driving in which the polarity of the voltage is inverted at regular time intervals may be adopted.

In addition, the driving circuit 11 applies the same voltage to the first adhesion improving film 28 and the second adhesion improving film 31. This can prevent the defect in which the first adhesion improving film 28 and the second adhesion improving film 31 short-circuit outside of the seal member 23, and can inhibit electrical corrosion of the first adhesion improving film 28 and the second adhesion improving film 31.

### [3] Comparative Example

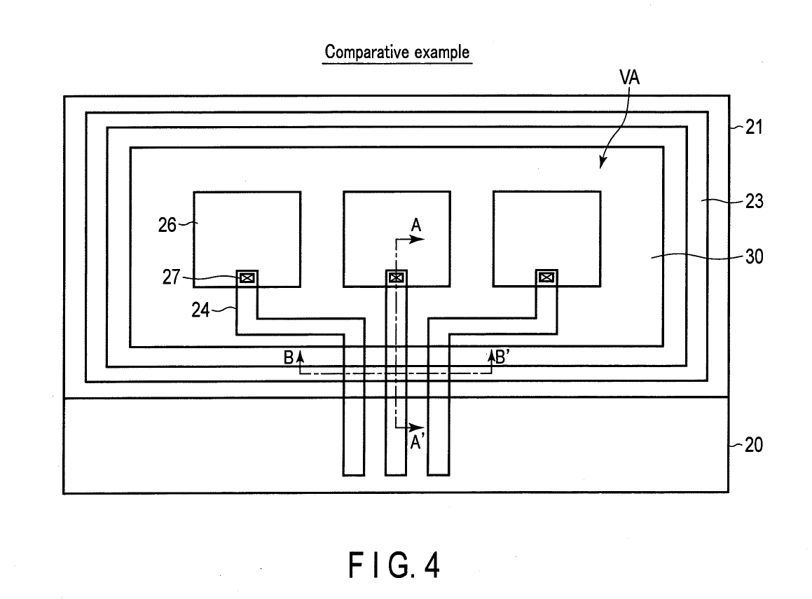

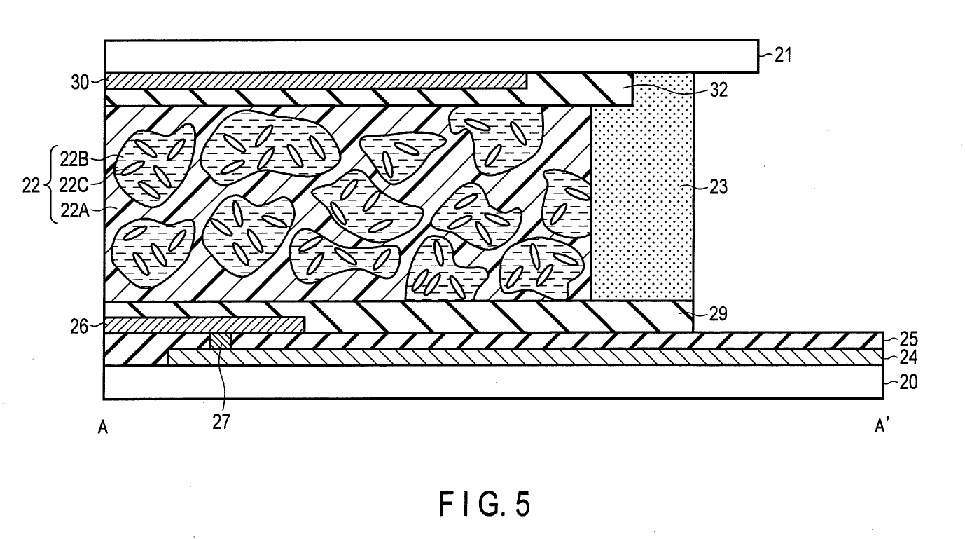

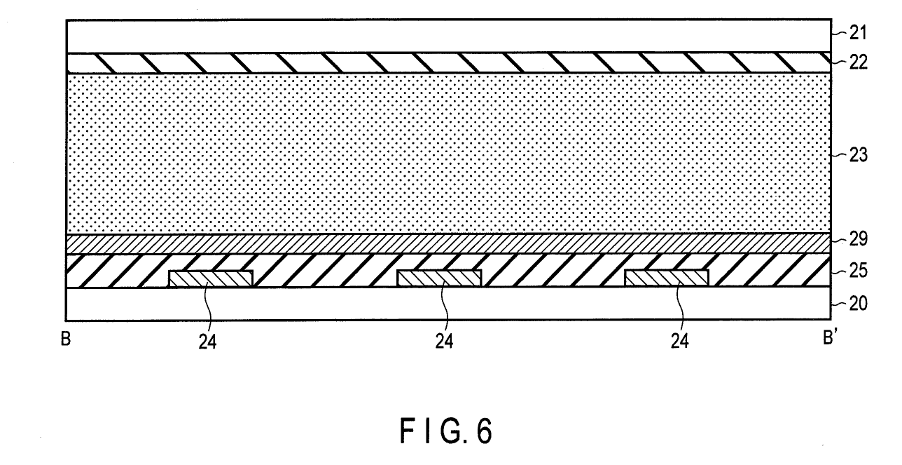

Next, a configuration of a liquid crystal display according to a comparative example will be described. FIG. 4 is a plane view of the liquid crystal display according to the comparative example. FIG. 5 is a cross-sectional view of the liquid crystal display taken along line A-A′ in FIG. 4. FIG. 6 is a cross-sectional view of the liquid crystal display taken along line B-B′ in FIG. 4.

In the comparative example, in an area where the seal member 23 is disposed, a lower surface (a surface on the first substrate 20 side) of the first organic insulating film 29 is in contact with the insulating film 25, and an upper surface of the first organic insulating film 29 is in contact with the seal member 23. Also, in the area where the seal member 23 is disposed, a lower surface (a surface on the second substrate 21 side) of the second organic insulating film 32 is in contact with the second substrate 21, and an upper surface of the second organic insulating film 32 is in contact with the seal member 23. Also, the seal member 23 is in contact with the second substrate 21.

The first organic insulating film 29, the second organic insulating film 32, and the seal member 23 have low adhesiveness. Therefore, in the comparative example, if a force is applied to the seal member 23 in a manufacturing process due to heat transfer at a time of LSI bonding, ultrasonic cleaning, etc., peeling occurs at an interface between the first organic insulating film 29 and the insulating film 25, and an interface between the second organic insulating film 32 and the second substrate 21, resulting in a decrease of the yield and reliability.

In contrast, according to the first embodiment, the liquid crystal display 10 further includes the first adhesion improving film 28 and the second adhesion improving film 31, thereby inhibiting peeling of the first organic insulating film 29 and the second organic insulating film 32.

### [4] Advantageous Effects

In the first embodiment, the first adhesion improving film 28 with high adhesiveness is provided between the insulating film 25 and the first organic insulating film 29 in the area where the seal member 23 is disposed, as detailed above. Also, the second adhesion improving film 31 with high adhesiveness is provided between the second substrate 21 and the second organic insulating film 32, and between the second substrate 21 and the seal member 23 in the area where the seal member 23 is disposed.

Therefore, according to the first embodiment, even if a force is applied to the seal member 23 in a manufacturing process due to heat transfer at a time of LSI bonding, ultrasonic cleaning, etc., peeling of the first organic insulating film 29 and the second organic insulating film 32 can be inhibited. Thereby, the liquid crystal display 10 that can inhibit a decrease of the yield, and reliability can be realized.

In addition, the same voltage is applied to the first adhesion improving film 28 and the second adhesion improving film 31 by the driving circuit 11. This can prevent the defect in which the first adhesion improving film 28 and the second adhesion improving film 31 short-circuit outside the seal member 23, and can inhibit electrical corrosion of the first adhesion improving film 28 and the second adhesion improving film 31.

In the first embodiment, the adhesion improving films, the organic insulating films, and the seal member are arranged to overlap one another on all of the four sides of the view area VA. However, the adhesion improving films may be provided only on one of the sides.

### Second Embodiment

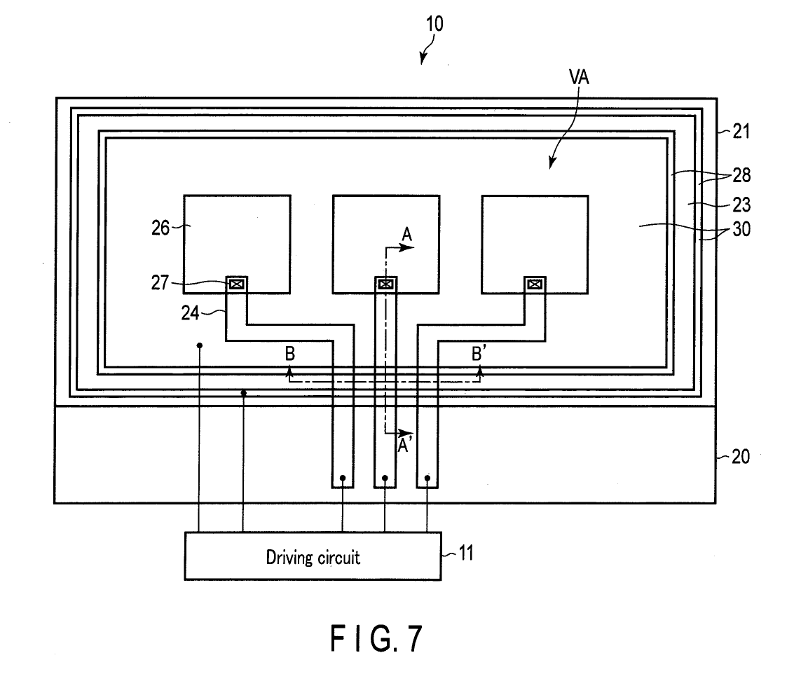

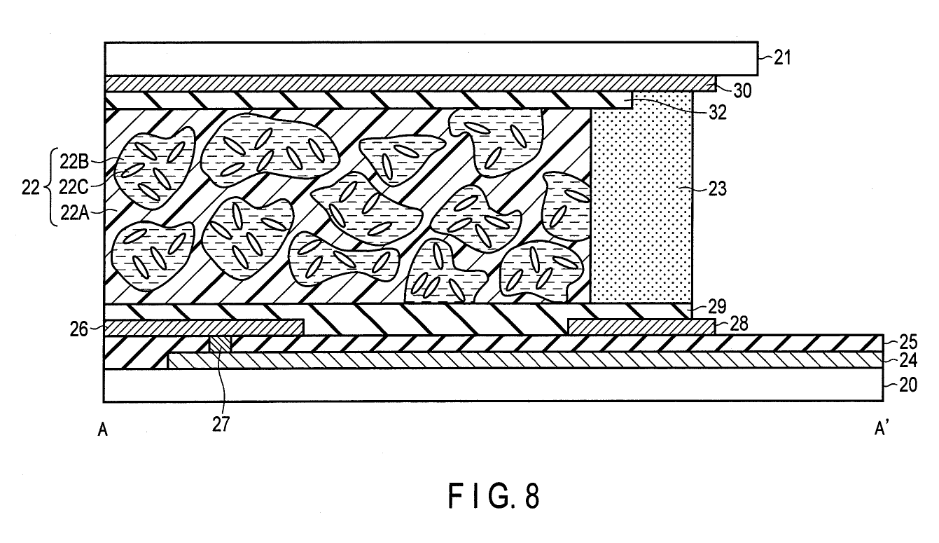

FIG. 7 is a plane view of the liquid crystal display 10 according to a second embodiment of the present invention. FIG. 8 is a cross-sectional view of the liquid crystal display 10 taken along line A-A′ in FIG. 7. A cross-sectional view of the liquid crystal display 10 taken along line B-B′ in FIG. 7 is the same as that shown in FIG. 3.

In the second embodiment, the common electrode 30 is formed to extend beyond the outer circumference of the seal member 23 in a planar view. Namely, the common electrode 30 also serves as the second adhesion improving film 31 shown in the first embodiment. In the configuration shown in FIG. 8 as well, peeling of the first organic insulating film 29 and the second organic insulating film 32 can be inhibited.

In addition, the same voltage that is applied to the common electrode 30 is applied to the first adhesion improving film 28 by the driving circuit 11. This can prevent the defect in which the first adhesion improving film 28 and the common electrode 30 short-circuit, and can inhibit electrical corrosion of the first adhesion improving film 28 and the common electrode 30.

### Third Embodiment

In the first embodiment, the first adhesion improving film is formed in a continuous pattern. In a third embodiment, however, to reduce the capacitance of the adjacent signal interconnections, the first adhesion improving film is formed to be divided in an island shape in an area where the first adhesion improving film and the signal interconnections overlap each other.

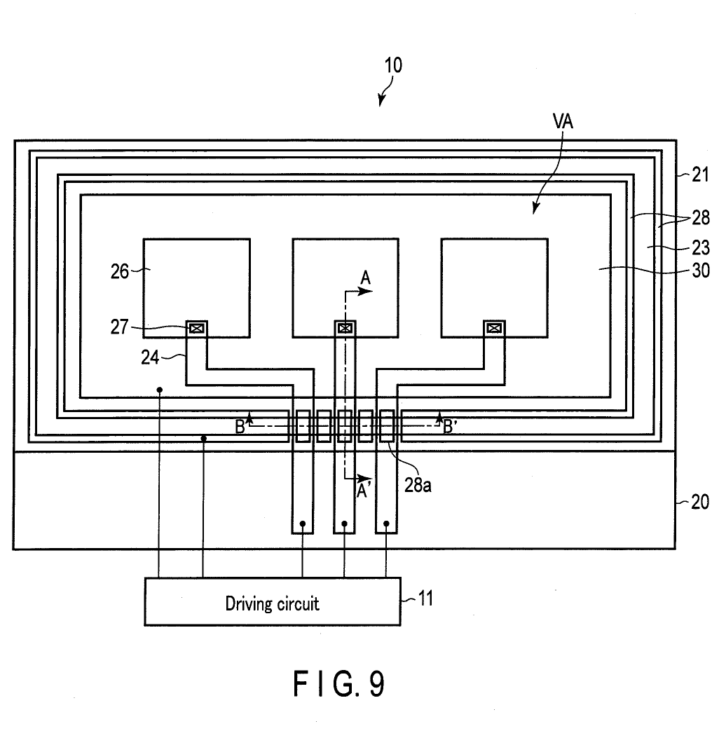

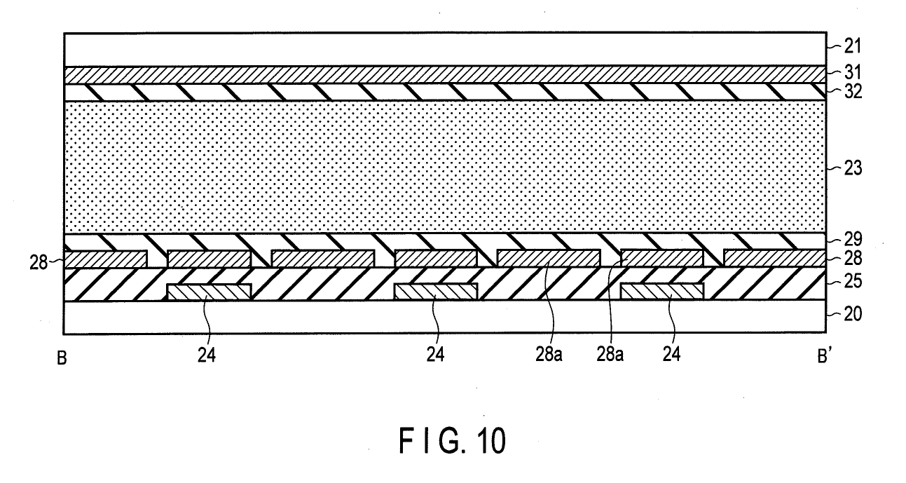

FIG. 9 is a plane view of the liquid crystal display according to the third embodiment of the present invention. FIG. 10 is a cross-sectional view of the liquid crystal display 10 taken along line B-B′ in FIG. 9. A cross-sectional view of the liquid crystal display 10 taken along line A-A′ in FIG. 9 is the same as that shown in FIG. 2. In FIG. 9, the second adhesion improving film 31 is not illustrated in order to simplify the figure. The second adhesion improving film 31 is formed in a frame shape so as to overlap with the seal member 23 in a planar view, in a manner similar to the first embodiment.

The first adhesion improving film 28 includes a plurality of island-shaped adhesion improving film portions 28a in an area where the first adhesion improving film 28 and the plurality of signal interconnections 24 overlap each other. Namely, the first adhesion improving film 28 is not a continuous film, but is divided into the plurality of adhesion improving film portions 28a that are insulated from each other in the area where the first adhesion improving film 28 and the plurality of signal interconnections 24 overlap each other. A voltage is not applied to the plurality of adhesion improving film portions 28a by the driving circuit 11, and the plurality of adhesion improving film portions 28a are in a floating state.

Configuring the first adhesion improving film 28 as described above can inhibit an increase of the parasitic capacitance between the adjacent signal interconnections 24. Thereby, the operation speed improves, and power consumption can be reduced.

If the first adhesion improving film 28 is a continuous film, destruction of the insulating film 25 between the first adhesion improving film 28 and the signal interconnections 24 and short-circuiting of the first adhesion improving film 28 and the signal interconnections 24 would make the liquid crystal display 10 defective. However, applying the structure of the third embodiment can prevent the liquid crystal display 10 from becoming defective even if the signal interconnections 24 and the adhesion improving film portions 28a short-circuit.

The second embodiment may be applied to the third embodiment.

The liquid crystal displays 10 of the first embodiment to the third embodiment described above may be applied to a pattern display-type liquid crystal display that displays characters or figures superimposed on a viewfinder of a camera, etc. The liquid crystal displays 10 of the first embodiment to the third embodiment described above may also be applied to a digital clock, a light control glass, a liquid crystal display that is capable of segment display, a liquid crystal display that is capable of matrix display, etc.

The present invention is not limited to the above-mentioned embodiments, and can be reduced to practice by modifying the constituent elements without departing from the spirit and scope of the invention. In addition, the above-described embodiments include inventions of various stages, and a variety of inventions can be derived by properly combining structural elements of one embodiment or by properly combining structural elements of different embodiments. For example, if the object of the invention is achieved and the advantages of the invention are attained even after some of the structural elements disclosed in connection with the embodiments are deleted, the structure made up of the resultant structural elements can be extracted as an invention.

What is claimed is:

1. A liquid crystal display comprising:
first and second substrates that are arranged opposite to each other;
a seal member that bonds the first and second substrates together;
a polymer dispersed liquid crystal layer that is enclosed in an area surrounded by the first and second substrates and the seal member;
a display electrode that is provided on the first substrate in a view area;
a first adhesion improving film that is provided on the first substrate so as to at least partially overlap with the seal member;
a first organic insulating film that is provided on the display electrode and the first adhesion improving film, and contacts the seal member;
a common electrode that is provided on the second substrate in the view area;
a second adhesion improving film that is provided on the second substrate so as to at least partially overlap with the seal member; and
a second organic insulating film that is provided on the common electrode and the second adhesion improving film, and contacts the seal member.

2. The liquid crystal display according to claim 1, wherein the first and second organic insulating films are polyimide films.

3. The liquid crystal display according to claim 1, wherein:
the first adhesion improving film is formed of a same material as that of the display electrode; and
the second adhesion improving film is formed of a same material as that of the common electrode.

4. The liquid crystal display according to claim 1, wherein the first and second adhesion improving films are ITO films.

5. The liquid crystal display according to claim 1, wherein the first and second adhesion improving films are set to a same voltage.

6. A liquid crystal display comprising:
first and second substrates that are arranged opposite to each other;
a seal member that bonds the first and second substrates together;
a polymer dispersed liquid crystal layer that is enclosed in an area surrounded by the first and second substrates and the seal member;
a signal interconnection that is provided on the first substrate;
an insulating film that is provided on the signal interconnection;
a display electrode that is provided on the insulating film in a view area and is electrically coupled to the signal interconnection via a contact plug;
a first adhesion improving film that is provided on the first substrate so as to at least partially overlap with the seal member;
a first organic insulating film that is provided on the display electrode and the first adhesion improving film, and contacts the seal member;
a common electrode that is provided on the second substrate in the view area;
a second adhesion improving film that is provided on the second substrate so as to at least partially overlap with the seal member; and
a second organic insulating film that is provided on the common electrode and the second adhesion improving film, and contacts the seal member,
wherein the first adhesion improving film is formed in a discontinuous manner to include a portion, the portion overlapping with the signal interconnection.

7. The liquid crystal display according to claim 6, wherein the first and second organic insulating films are polyimide films.

8. The liquid crystal display according to claim 6, wherein:
the first adhesion improving film is formed of a same material as that of the display electrode; and
the second adhesion improving film is formed of a same material as that of the common electrode.

9. The liquid crystal display according to claim 6, wherein the first and second adhesion improving films are ITO films.

10. The liquid crystal display according to claim 6, wherein the first and second adhesion improving films are set to a same voltage.
